(19) United States
(12) Patent Application Publication
(10) Pub. No.: US 2023/0367466 A1
(43) Pub. Date: Nov. 16, 2023

(54) INFORMATION DISPLAY METHOD BASED ON SESSION, APPARATUS, DEVICE, STORAGE MEDIUM, AND PROGRAM PRODUCT

(71) Applicant: TENCENT TECHNOLOGY (SHENZHEN) COMPANY LIMITED, Shenzhen (CN)

(72) Inventor: Jianping YANG, Shenzhen (CN)

(21) Appl. No.: 18/356,271

(22) Filed: Jul. 21, 2023

Related U.S. Application Data
(63) Continuation of application No. PCT/CN2022/125601, filed on Oct. 17, 2022.

(30) Foreign Application Priority Data
Nov. 30, 2021 (CN) 202111441440.7

(51) Int. Cl. G06F 3/04845; G06T 13/80; G06F 3/0481; G06F 3/0486; G06F 3/04842

(52) U.S. Cl. CPC G06F 3/04845; G06T 13/80; G06F 3/0481; G06F 3/0486; G06F 3/04842; G06T 2200/24

(57) ABSTRACT

An information display method based on session performed by an electronic device includes presenting at least one emoticon element in a session interface that is configured to implement a session with at least one session object, in response to an ejection operation for a target emoticon element in the at least one emoticon element, presenting ejection guidance information corresponding to the target emoticon element, and displaying an ejection animation of the target emoticon element being ejected in response to an ejection instruction triggered based on the ejection guidance information.

### CROSS-REFERENCE TO RELATED APPLICATIONS

This application is a continuation of International Application No. PCT/CN2022/125601, filed on Oct. 17, 2022, which claims priority to Chinese Patent Application No. 202111441440.7, filed on Nov. 30, 2021, which are incorporated herein by reference in their entirety.

### FIELD OF THE TECHNOLOGY

This application relates to the field of the instant messaging technology and, in particular, to an information display method based on session, an apparatus, a device, a computer-readable storage medium, and a computer program product.

### BACKGROUND OF THE DISCLOSURE

With the development of the mobile communication technology, in the session process of instant messaging, users can transmit session messages by editing text, voices, emoticon elements, or the like. However, in related technologies, emoticon elements are usually transmitted in a mode of message bubbles, that is, the transmitted emoticon elements are displayed in the form of session messages. This information display mode is relatively simple, resulting in lower utilization ratio of graphics processing resources.

### SUMMARY

In accordance with the disclosure, there is provided an information display method based on session performed by an electronic device and including presenting at least one emoticon element in a session interface that is configured to implement a session with at least one session object, in response to an ejection operation for a target emoticon element in the at least one emoticon element, presenting ejection guidance information corresponding to the target emoticon element, and displaying an ejection animation of the target emoticon element being ejected in response to an ejection instruction triggered based on the ejection guidance information.

Also in accordance with the disclosure, there is provided an electronic device including one or more memories storing one or more executable instructions and one or more processors configured to execute the one or more executable instructions to present at least one emoticon element in a session interface that is configured to implement a session with at least one session object, in response to an ejection operation for a target emoticon element in the at least one emoticon element, present ejection guidance information corresponding to the target emoticon element, and display an ejection animation of the target emoticon element being ejected in response to an ejection instruction triggered based on the ejection guidance information.

Also in accordance with the disclosure, there is provided a computer-readable storage medium storing one or more executable instructions that, when executed by one or more processors, cause the one or more processors to present at least one emoticon element in a session interface that is configured to implement a session with at least one session object, in response to an ejection operation for a target emoticon element in the at least one emoticon element, present ejection guidance information corresponding to the target emoticon element, and display an ejection animation of the target emoticon element being ejected in response to an ejection instruction triggered based on the ejection guidance information.

### BRIEF DESCRIPTION OF THE DRAWINGS

FIG. 1 shows a schematic architectural diagram of an information display system 100 based on session provided in an embodiment of this application.

FIG. 2 shows a schematic structural diagram of an electronic device 500 provided in an embodiment of this application.

FIG. 3 shows a schematic flowchart of an information display method based on session provided in an embodiment of this application.

FIG. 4 shows schematic diagrams showing reception of an ejection operation provided in an embodiment of this application.

FIG. 5 shows schematic diagrams showing presentation of ejection guidance information provided in an embodiment of this application.

FIG. 6 shows schematic diagrams showing adjustment of an ejection direction provided in an embodiment of this application.

FIG. 7 to FIG. 10 show schematic diagrams showing ejection of a target emoticon element provided in an embodiment of this application.

FIG. 11 shows a schematic diagram showing display of ejection information provided in an embodiment of this application.

FIG. 12 shows schematic diagrams showing display of information provided in an embodiment of this application.

FIG. 13 to FIG. 16 show schematic diagrams showing collision between emoticon elements provided in an embodiment of this application.

FIG. 17 shows a schematic flowchart of an information display method based on session provided in an embodiment of this application.

### DESCRIPTION OF EMBODIMENTS

To make the objectives, technical solutions, and advantages of this application clearer, the following describes this application in further detail with reference to the accompanying drawings. The described embodiments are not to be considered as a limitation to this application. All other embodiments obtained by a person of ordinary skill in the art without creative efforts shall fall within the protection scope of this application.

In the following description, the term “some embodiments” describes subsets of all possible embodiments, but it may be understood that “some embodiments” may be the same subset or different subsets of all the possible embodiments, and may be combined with each other without conflict.

In the following description, the involved terms “first,” “second,” and the like are merely intended to distinguish similar objects, but do not represent a specific order of objects. It can be understood that the “first,” “second,” and the like may be interchanged in a specific order or a sequential order if allowed, so that the embodiments of this application described herein may be implemented in an order other than those illustrated or described herein.

Unless otherwise defined, meanings of all technical and scientific terms used in this specification are the same as those usually understood by a person skilled in the art to which this application belongs. Terms used in the specification are merely intended to describe objectives of the embodiments of this application, but are not intended to limit this application.

In this disclosure, processes or steps described in a certain order do not have to be performed in the order they are described, and can be performed in a different order or simultaneously.

Before the embodiments of this application are described in detail, nouns and terms involved in the embodiments of this application are described, and the nouns and terms involved in the embodiments of this application are applicable to the following explanations.
1) Clients: Applications running in terminals to provide various services, such as video playback clients, game clients, instant messaging clients, and learning clients.
2) “In response to” is used for indicating a condition or a state on which the executed operation depends. When the dependent condition or state is met, one or more executed operations may be real-time or may have a set delay; and unless otherwise specified, there is no restriction on the execution order of multiple executed operations.

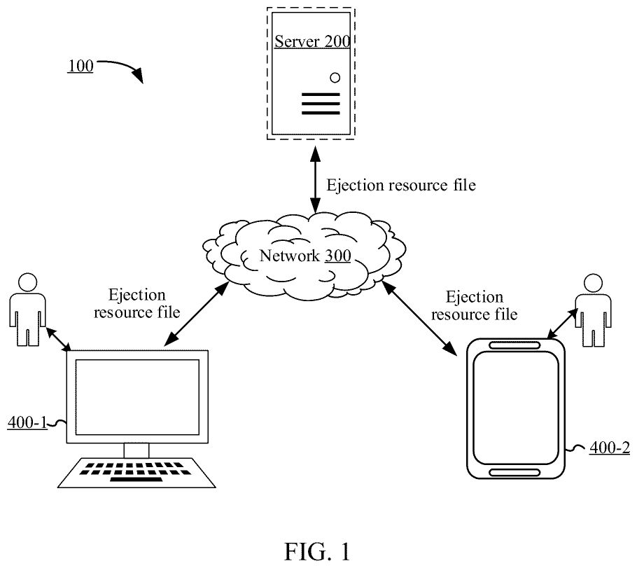

Referring to FIG. 1, FIG. 1 shows a schematic architectural diagram of an information display system 100 based on session provided in an embodiment of this application. In order to support an exemplary application, terminals (for example, a terminal 400-1 and a terminal 400-2) are connected to a server 200 through a network 300. The network 300 may be a wide area network, a local area network, or a combination of the wide area network and the local area network, and uses wireless links for data transmission.

In a practical application, the terminal 400 may be various types of user terminals, such as a smart phone, a tablet computer, a notebook computer and a virtual reality (VR) device, or may be a desktop computer, a television or a combination of any two or more of these data processing devices. The server 200 may be a separately configured server supporting various services, may be configured as a server cluster, or may be a cloud server.

In a practical application, a terminal is provided with clients, such as a video playback client, a game client, an instant messaging client and a learning client. When a user opens a client on the terminal for a session, the terminal presents at least one emoticon element in a session interface, where the session interface is configured to implement a session with at least one session object; ejection guidance information corresponding to the target emoticon element is presented in response to an ejection operation for a target emoticon element in the at least one emoticon element; an ejection request for the target emoticon element is transmitted to the server 200 in response to an ejection instruction triggered based on the ejection guidance information; the server 200 determines an ejection resource file for the target emoticon element being ejected based on the ejection request, and returns the determined ejection resource file to the terminals of the current object and the session object; and after receiving the ejection resource file, the terminal renders the ejection resource file and displays the rendered ejection animation for the target emoticon element being ejected in the session interface.

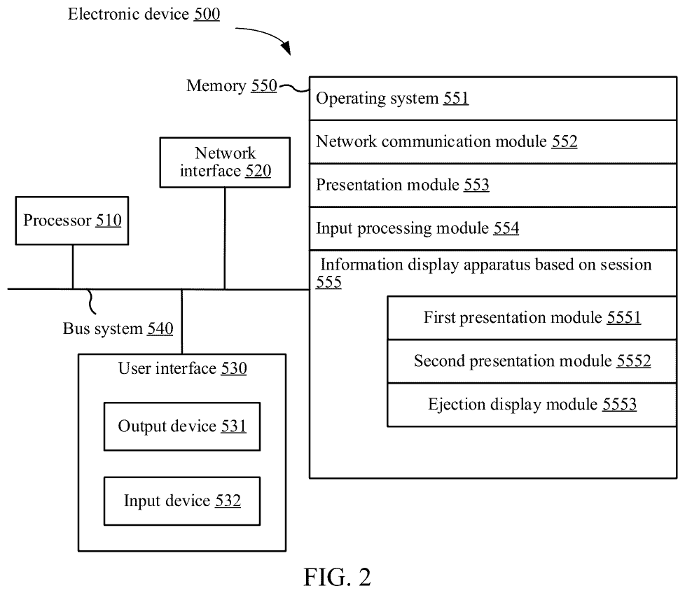

Referring to FIG. 2, FIG. 2 shows a schematic structural diagram of an electronic device 500 provided in an embodiment of this application. In a practical application, the electronic device 500 may be a terminal or a server 200 in FIG. 1. Taking the electronic device which is a terminal shown in FIG. 1 as an example, the electronic device for implementing an information display method based on session in an embodiment of this application is described. The electronic device 500 shown in FIG. 2 includes: at least one processor 510, a memory 550, at least one network interface 520, and a user interface 530. All components in the electronic device 500 are coupled together through a bus system 540. It may be understood that the bus system 540 is configured to implement connection and communication between the components. In addition to a data bus, the bus system 540 further includes a power bus, a control bus, and a state signal bus. But, for ease of clear description, all types of buses in FIG. 2 are marked as the bus system 540.

The processor 510 may be an integrated circuit chip with a signal processing capability, such as a general purpose processor, a digital signal processor (DSP), another programmable logic device, discrete gate or transistor logic device, or discrete hardware assembly, or the like, where the general purpose processor may be a microprocessor or any conventional processor.

The user interface 530 includes one or more output devices 531 capable of presenting media contents, and includes one or more speakers and/or one or more visual display screens. The user interface 530 further includes one or more input devices 532, including user interface components that facilitate user input, such as keyboards, mouses, microphones, touch screen displays, cameras, other input buttons and controls.

The memory 550 may be removable, non-removable, or a combination thereof. Exemplary hardware devices include solid-state memories, hard disk drives, optical disk drives, and the like. The memory 550 may optionally include one or more storage devices away from the processor 510 in a physical position.

The memory 550 includes a volatile memory or a non-volatile memory, or may include both a volatile memory and a non-volatile memory. The non-volatile memory may be a read only memory (ROM), and the volatile memory may be a random access memory (RAM). The memory 550 described in this embodiment of this application is intended to include any suitable type of memory.

In some embodiments, the memory 550 may store data to support various operations. Examples of these data include programs, modules and data structures or subsets or supersets thereof, as exemplified below.

An operating system 551 includes system programs configured to process various basic system services and perform hardware related tasks, such as a frame layer, a core library layer, and a drive layer for implementing various basic services and processing tasks based on hardware.

A network communication module 552 is configured to reach other computing devices via one or more (wired or wireless) network interfaces 520, and exemplary network interfaces 520 include: Bluetooth, wireless fidelity (WiFi), a universal serial bus (USB), and the like.

A presentation module 553 is configured to present information (such as a user interface for operating a peripheral device and displaying content and information) through one or more output devices 531 associated with the user interface 530 (such as a display screen and a speaker).

An input processing module 554 is configured to detect one or more user inputs or interactions from one of one or more input devices 532, and translate the detected input or interaction.

In some embodiments, an information display apparatus based on session provided in an embodiment of this application may be implemented in a mode of software. FIG. 2 shows an information display apparatus 555 based on session stored in the memory 550, which may be software in the form of programs and plug-ins, including the following software modules: a first presentation module 5551, a second presentation module 5552, and an ejection display module 5553. These modules are logical modules, and thus may be randomly combined or further divided according to implemented functions. Functions of each module are described below.

In some embodiments, an information display apparatus based on session provided in an embodiment of this application may be implemented in a mode of hardware. As an example, an information display apparatus based on session provided in an embodiment of this application may be a processor in the form of a hardware decoding processor, and is programmed to perform an information display method based on session provided in an embodiment of this application. For example, the processor in the form of a hardware decoding processor may adopt one or more application specific integrated circuits (ASICs), DSPs, programmable logic devices (PLDs), complex programmable logic devices (CPLDs), field-programmable gate arrays (FPGAs), or other electronic components.

In some embodiments, a terminal or a server may implement an information display method based on session provided in an embodiment of this application by running a computer program. For example, a computer program may be a native program or a software module in an operating system; may be a native application (APP), that is, a program that needs to be installed in an operating system to run, such as a live streaming APP or an instant messaging APP; may be an applet, that is, a program that may run only by being downloaded into a browser environment; or may be an applet that may be embedded into any APP. In summary, the foregoing computer program may be any form of application, module, or plug-in.

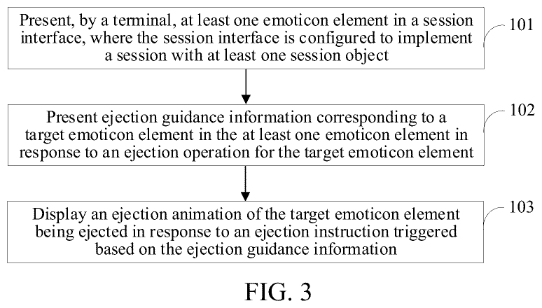

Based on the foregoing description of an information display system based on session provided in an embodiment of this application, an information display method based on session provided in an embodiment of this application is described below. In a practical implementation, the method may be implemented separately by a terminal or the server 200 shown in FIG. 1, or may be implemented cooperatively by a terminal and the server 200 shown in FIG. 1. With reference to FIG. 1 and FIG. 3, FIG. 3 shows a schematic flowchart of an information display method based on session provided in an embodiment of this application, and a terminal shown in FIG. 1 is taken to separately implement the information display method based on session provided in the embodiment of this application as an example for description.

Step 101: Present, by the terminal, at least one emoticon element in a session interface, where the session interface is configured to implement a session with at least one session object.

In a practical application, the terminal is provided with clients, such as a video playback client, a game client, an instant messaging client and a learning client. When a user opens a client on the terminal for a session, a session interface for the session is presented. The session interface may be an interface for a session between two session objects, or an interface for a session between session groups composed of two or more session objects. A session editing region for session editing may be presented in the session interface, and text, voices, pictures, emoticon elements and other contents may be edited and transmitted through the session editing region. When the user taps an emoticon entry to edit emoticon elements, the terminal presents multiple selectable emoticon elements in response to a tap operation, so that the user may select any one of the emoticon elements as a target emoticon element to be transmitted or ejected.

In addition, a session message may also be presented in the session interface. The session message may be a message edited by a session object corresponding to the current login account through a session editing region (such as a message editing box), or a session message transmitted by the server and edited by other session objects that are not corresponding to the current login account. The session message may include at least one of the following types of session messages: a text message, an audio message, a video message, an emoticon element message, and the like.

Step 102: Present ejection guidance information corresponding to a target emoticon element in the at least one emoticon element in response to an ejection operation for the target emoticon element.

In some embodiments, before presenting ejection guidance information corresponding to the target emoticon element, the terminal may receive an ejection operation by: receiving a trigger operation for the target emoticon element in the at least one emoticon element, and determining the trigger operation as the ejection operation in a case that the trigger operation meets at least one of the following conditions: a trigger duration reaches a target duration, a trigger displacement reaches a target displacement, and a trigger trajectory is a target trajectory.

Here, for emoticon elements, a trigger operation that may trigger an ejection operation may be preset. When the trigger operation performed by the user for emoticon elements is consistent with the preset trigger operation that may trigger the ejection operation, the terminal may receive the ejection operation for the corresponding emoticon element. For example, when at least one of the following preset trigger operations is performed for the target emoticon element: a long press operation (a trigger duration reaches a preset target duration, such as 1 s), a drag operation (for example, pulling down the target emoticon element to a certain position), and an operation of dragging the target emoticon element to move along a target trajectory (for example, dragging the target emoticon element to draw a circle), the trigger operation is determined as the ejection operation.

In some other embodiments, before presenting ejection guidance information corresponding to the target emoticon element, the terminal may further receive an ejection operation by: receiving an operation combination for the target emoticon element in the at least one emoticon element, the operation combination including at least two continuous operations, and determining the operation combination as the ejection operation in a case that the operation combination is consistent with a target operation combination.

Here, the target operation combination is described. In a practical application, the target operation combination may be a preset combination of at least two trigger operations, and the trigger operation may be a long press operation, a drag operation, a tap operation or a swipe operation. When the operation combination including at least two continuous operations (for example, first long pressing the target emoticon element and then dragging the target emoticon element downward) performed by the user for the target emoticon element is consistent with the preset target operation combination, the operation combination is determined as the ejection operation.

In some embodiments, before presenting ejection guidance information corresponding to the target emoticon element, the terminal may further receive an ejection operation by: presenting a transmitting mode selection interface for selecting a transmitting mode of the target emoticon element in response to a trigger operation for the target emoticon element in the at least one emoticon element, where the transmitting mode selection interface at least includes an ejection mode option; and determining the selection operation as the ejection operation in response to a selection operation for the ejection mode option.

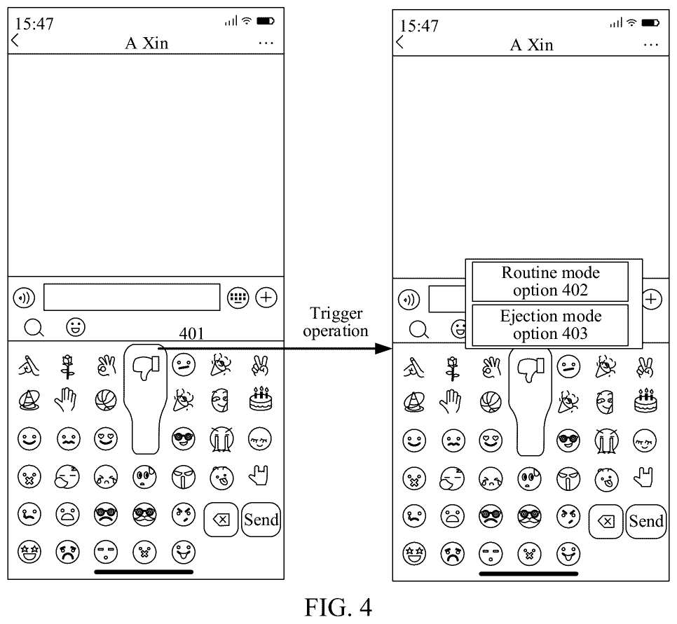

Here, multiple transmitting modes may be preset for any emoticon element, such as a routine mode and an ejection mode, where the routine mode means that a routine operation corresponding to a transmitting instruction is performed to achieve simple transmission of emoticon elements; and the ejection mode means that an ejection operation corresponding to an ejection instruction is performed to achieve ejection transmission of emoticon elements. Referring to FIG. 4, FIG. 4 shows schematic diagrams showing reception of an ejection operation provided in an embodiment of this application. In a practical application, when a user triggers (such as double-taps or swipes) a target emoticon element 401, a terminal presents mode options in response to the trigger operation for the user to select a transmitting mode of the target emoticon element, such as a routine mode option 402 and an ejection mode option 403. When the user selects the ejection mode option 403, the terminal may receive an ejection operation for the target emoticon element.

In a practical application, a mode option may also be presented in a mode selection interface. For example, a terminal may first present the mode selection interface in the form of a pop-up window or a sub-interface independent of a session interface in response to a trigger operation for the target emoticon element, the routine mode option and the ejection mode option are presented in the mode selection interface, and the selection operation is determined as the ejection operation in response to a selection operation for the ejection mode option. In this way, when the user does not understand the transmitting modes of emoticon elements, first, multiple transmitting modes are presented for the user to select, and the user may select the corresponding transmitting mode based on the curiosity or practical needs, which is favorable for promoting the interactivity for emoticon elements.

In a practical application, when it is determined that the user has a sufficient understanding of the transmitting modes of emoticon elements based on the historically used data of the user, it is also possible to directly respond to the corresponding operation (such as the routine operation or the ejection operation) without presenting transmitting mode options. For example, for the target emoticon element, assuming that a corresponding transmitting instruction may be triggered when a tap operation for the target emoticon element is received and a corresponding ejection instruction may be triggered when a long press operation for the target emoticon element is received, when the user taps the target emoticon element, the terminal receives the transmitting instruction for the target emoticon element in response to the tap operation, and transmits the target emoticon element in the form of a message bubble in response to the transmitting instruction, so as to present a session message including the target emoticon element in the session interface; and when the user long presses the target emoticon element, the terminal receives the ejection instruction for the target emoticon element in response to the long press operation (that is, the ejection operation), and transmits the target emoticon element in the form of ejection in response to the ejection instruction, so as to display an ejection animation of the target emoticon element being ejected in the session interface. Thus, an operation path performed for transmitting emoticon elements is shortened, and the interaction efficiency is improved.

It is to be understood that in the embodiments of this application, relevant data such as historically used data of users are involved; when specific products or technologies are used in the embodiments of this application, it is needed to obtain user permission or consent; and the collection, use and processing of the relevant data need to comply with relevant laws, regulations and standards of relevant countries and regions.

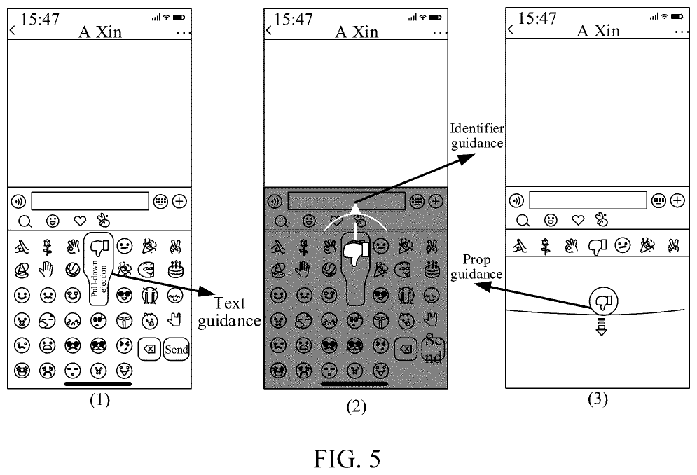

In some embodiments, the ejection guidance information is used for guiding the execution of corresponding processing for the ejection operation to trigger the ejection instruction. For example, the guidance information is used for guiding the release of the ejection operation (such as loosening, that is, loosening the ejection operation for the target emoticon element) to trigger the ejection instruction, where the presentation form may be text guidance, identifier guidance, or auxiliary prop guidance. For example, referring to FIG. 5, FIG. 5 shows schematic diagrams showing presentation of ejection guidance information provided in an embodiment of this application. In part (1) of FIG. 5, the text guidance such as “pull-down ejection” is used as ejection guidance information; in part (2) of FIG. 5, the identifier guidance, namely the arrow, is used as ejection guidance information, where the direction of the arrow indicates an ejection direction, and the length of the arrow indicates the corresponding ejection distance; and in part (3) of FIG. 5, auxiliary props such as slingshots or bows and arrows are used as ejection guidance information, so that users may perform an ejection operation for emoticon elements to endow the interactions of emoticon elements with game-oriented gameplay, which enhances the interactive interest based on emoticon elements.

In some embodiments, after presenting ejection guidance information corresponding to the target emoticon element, the terminal may receive an ejection instruction for the target emoticon element by: displaying a process of dragging the target emoticon element in response to a drag operation for the target emoticon element triggered based on the ejection guidance information; and receiving an ejection instruction for the target emoticon element in response to a release instruction for the drag operation. That is, under the operation guidance of the ejection guidance information, the user may drag the target emoticon element to move in the session interface. In the process of dragging the target emoticon element to move, when the user releases the drag operation for the target emoticon element, an ejection instruction for the target emoticon element is triggered.

Here, in a practical application, the target emoticon element may be dragged based on the ejection guidance information, where the drag direction of the drag operation determines the ejection direction of the target emoticon element, and the drag direction and ejection direction are opposite to each other; and the drag distance of the drag operation determines the ejection distance of the target emoticon element being ejected, and the ejection distance is positively correlated with the drag distance, that is, the longer the drag distance, the longer the corresponding ejection distance. When the drag operation is released after the target emoticon element is dragged to any position, an ejection instruction for the target emoticon element may be received.

In some embodiments, before receiving an ejection instruction for the target emoticon element, the terminal may further adjust the ejection direction of the target emoticon element in response to a rotation operation for the target emoticon element. Correspondingly, the terminal may receive an ejection instruction by: receiving an ejection instruction for instructing ejection in the adjusted ejection direction.

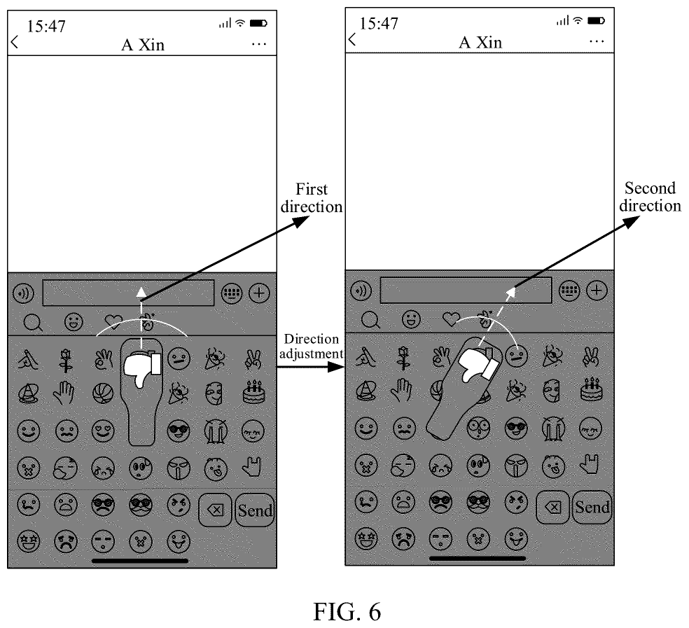

Here, in the process of dragging the target emoticon element, or when the target emoticon element is dragged to a target position, the ejection direction of the target emoticon element may be adjusted through the rotation operation for the target emoticon element. For example, referring to FIG. 6, FIG. 6 shows schematic diagrams showing adjustment of an ejection direction provided in an embodiment of this application. When the user starts dragging the target emoticon element, the ejection direction indicated by the target emoticon element is a first direction. In the process of dragging the target emoticon element, the ejection direction indicated by the target emoticon element is adjusted from the first direction to a second direction by rotating the target emoticon element. At this time, if the user releases the drag operation, the ejection direction indicated by the ejection instruction received by the terminal is the second direction.

In some embodiments, after presenting ejection guidance information corresponding to the target emoticon element, the terminal may receive an ejection instruction for the target emoticon element by: presenting a first ejection auxiliary tool of the ejection prop in a case that the presentation form of the ejection guidance information is an ejection prop carrying the target emoticon element; displaying a process of dragging the ejection prop and a process of dragging the ejection prop to deform the first ejection auxiliary tool in response to a drag operation for the ejection prop; and receiving the ejection instruction in response to a release instruction for the drag operation. Correspondingly, the terminal may display an ejection animation of the target emoticon element being ejected in the session interface by: displaying an animation of the target emoticon element being ejected under the action of the elastic force generated by the first ejection auxiliary tool restoring to an original shape in the session interface.

Here, the ejection guidance information exists in the form of an ejection prop and is used for indicating the use of the ejection prop to eject the target emoticon element, where the ejection prop carries the target emoticon element, that is, the ejection prop uses the target emoticon element as a carrier, and the style of the ejection prop is consistent with the style of the target emoticon element. For example, if the target emoticon element is a smile emoticon, the style of the ejection prop is also a smile emoticon. Before the ejection prop (that is, the target emoticon element) is ejected, it is needed to drag the ejection prop to accumulate force. The first ejection auxiliary tool is a virtual elastic tool (such as a virtual elastic rope) that may deform under the action of the accumulated force, and is configured to assist in triggering the ejection operation for the ejection prop. In the process of dragging the ejection prop, the first ejection auxiliary tool and the ejection prop form an organic whole, and the first ejection auxiliary tool is in contact with the ejection prop. With the drag operation for the ejection prop, the ejection prop applies pressure to the first ejection auxiliary tool, so that the first ejection auxiliary tool undergoes corresponding deformation under the drag force of the drag operation, and generates elastic force for ejecting the ejection prop. When the drag operation is released, the terminal receives an ejection instruction for the ejection prop (that is, the target emoticon element) in response to the release instruction for the drag operation, and displays an ejection animation of the ejection prop (that is, the target emoticon element) being ejected under the action of the elastic force generated by the first ejection auxiliary tool restored from the deformation to an original shape. In a practical application, in the ejection animation, the distance at which the target emoticon element is ejected is positively correlated with the magnitude of the elastic force generated by the first ejection auxiliary tool, and the magnitude of the elastic force generated by the first ejection auxiliary tool is positively correlated with the degree of deformation of the first ejection auxiliary tool.

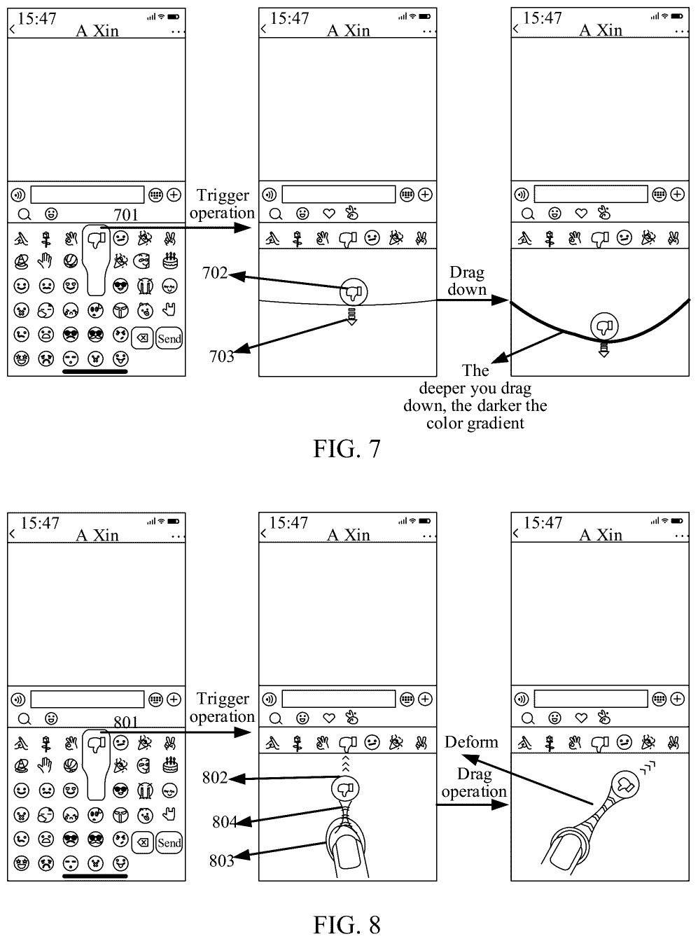

Referring to FIG. 7, FIG. 7 shows schematic diagrams showing ejection of a target emoticon element provided in an embodiment of this application. When the user long presses a target emoticon element 701, an ejection prop 702 is presented at a target position of the session interface (such as the lower middle part of the session interface), the style of the ejection prop 702 is consistent with the style of the target emoticon element 701, and a first ejection auxiliary tool 703 corresponding to the ejection prop 702 and guidance information 704 for guiding to drag the ejection prop are presented. In the process of dragging the ejection prop 702 downward by the user according to the guidance information 704, a process of the corresponding deformation of the first ejection auxiliary tool 703 is presented. When the user releases the ejection prop 702, an animation of the ejection prop 702 (that is, the target emoticon element) being ejected under the action of the elastic force generated by the first auxiliary tool 703 restored from the deformation to an original shape is presented.

In some embodiments, in the process of dragging the ejection prop, with the change of the position of the ejection prop, the display style of the first ejection auxiliary tool is adjusted, so as to enable the display style of the first ejection auxiliary tool to correspond to the position of the ejection prop.

Here, in the process of dragging the ejection prop, the position of the ejection prop changes with the drag operation, so that the first ejection auxiliary tool undergoes corresponding deformation, and the display style also undergoes a corresponding change. As shown in FIG. 7, the lower the drag position for the drag operation of the ejection prop 702, the larger the deformation corresponding to the first ejection auxiliary tool 703, the larger the accumulated force generated, and correspondingly, the darker the color gradient of the first ejection auxiliary tool 703 visually.

In some embodiments, after presenting ejection guidance information corresponding to the target emoticon element, the terminal may receive an ejection instruction for the target emoticon element by: presenting a second ejection auxiliary tool connected to the ejection prop in response to a trigger operation for the ejection prop in a case that the presentation form of the ejection guidance information is an ejection prop carrying the target emoticon element; displaying a movement process of the second ejection auxiliary tool and displaying a process of stretching deformation of a connecting member between the second ejection auxiliary tool and the ejection prop with the movement of the second ejection auxiliary tool in response to a drag operation for the second ejection auxiliary tool; and receiving the ejection instruction in response to a release instruction for the drag operation. Correspondingly, the terminal may display an ejection animation of the target emoticon element being ejected in the session interface by: displaying an ejection animation of the target emoticon element being ejected under the action of the elastic force generated by stretching deformation of the connecting member in the session interface.

Before the ejection prop (that is, the target emoticon element) is ejected, when the user triggers the ejection prop, the second ejection auxiliary tool (such as a pull ring) connected to the ejection prop through the connecting member is presented. When the second ejection auxiliary tool is dragged, the connecting member undergoes corresponding stretching deformation. As a result, due to the corresponding elastic force generated by stretching deformation of the connecting member, in the process of dragging the second ejection auxiliary tool, the farther the second ejection auxiliary tool is dragged, the larger the deformation of the connecting member, and the larger the elastic force generated by stretching deformation of the connecting member. When the drag operation is released, under the action of the elastic force generated by stretching deformation of the connecting member, the distance at which the ejection prop (that is, the target emoticon element) is ejected becomes farther.

Referring to FIG. 8, FIG. 8 shows schematic diagrams showing ejection of a target emoticon element provided in an embodiment of this application. When the user long presses a target emoticon element 801, an ejection prop 802 is presented at a target position of the session interface (such as the lower middle part of the session interface), the style of the ejection prop 802 is consistent with the style of the target emoticon element 801, and a second ejection auxiliary tool 803 corresponding to the ejection prop 802 and a connecting member 804 for connecting the ejection prop 802 and the second ejection auxiliary tool 803 are presented. In the process of dragging the second ejection auxiliary tool 803, the farther the second ejection auxiliary tool 803 is dragged, the larger the deformation of the connecting member 804, and the larger the elastic force (accumulated force value) generated by stretching deformation of the connecting member 804. When the user releases the drag operation, in an animation of the presented ejection prop (that is, the target emoticon element) being ejected under the action of the elastic force generated by stretching deformation of the connecting member 804, the distance at which the ejection prop (that is, the target emoticon element) is ejected becomes farther.

Step 103: Display an ejection animation of the target emoticon element being ejected in response to an ejection instruction triggered based on the ejection guidance information.

In some embodiments, the terminal may display an ejection animation of the target emoticon element being ejected by: displaying, by the terminal, a process of the target emoticon element being ejected and then moving to an edge of the session interface and disappearing in the session interface. In a practical application, when receiving an ejection instruction for the target emoticon element, the terminal displays an ejection animation of the target emoticon element being ejected. For example, the terminal displays a process of ejecting the target emoticon element from the first position (initial position) in an emoticon panel of the target emoticon element to the edge position in the session interface until the target emoticon element is ejected out of the session interface; or, the terminal displays a process of ejecting the target emoticon element from the second position (such as the release position of the drag operation) of the target emoticon element when the ejection instruction is triggered to the edge position in the session interface until the target emoticon element is ejected out of the session interface, where the first position is different from the second position, and the ejection direction of the target emoticon element is vertically upward along the ejection direction instructed by the ejection instruction by using the session interface as a reference interface.

The ejection mode may be similar to a “rocket” style for ejection, a “step-up” style for gradual bounce, or other ejection forms for ejection. The ejection form is not limited in the embodiments of this application.

In an ejection process, if the elastic force for the target emoticon element is insufficient to cause the target emoticon element to be ejected from the session interface along the original ejection direction, a process of the target emoticon element being ejected along other directions until leaving the session interface may be displayed. For example, when the target emoticon element is ejected from the bottom of the session interface upwards, before the target emoticon element reaches an upper edge of the session interface, if the target emoticon element stops being ejected upwards at a middle position, a process of the target emoticon element falling down from the middle position until leaving the session interface from a lower edge is displayed. Through the above mode, the process of the target emoticon element being ejected is dynamically displayed in the session interface, thereby enriching display forms, increasing the atmosphere of emoticon elements, and being more conducive to emotional expression.

In some embodiments, the terminal may further display an ejection animation of the target emoticon element being ejected in the session interface by: displaying a process of the target emoticon element being ejected and moving along the ejection direction instructed by the ejection instruction in the session interface; and controlling the size of the target emoticon element to gradually change with the movement of the target emoticon element.

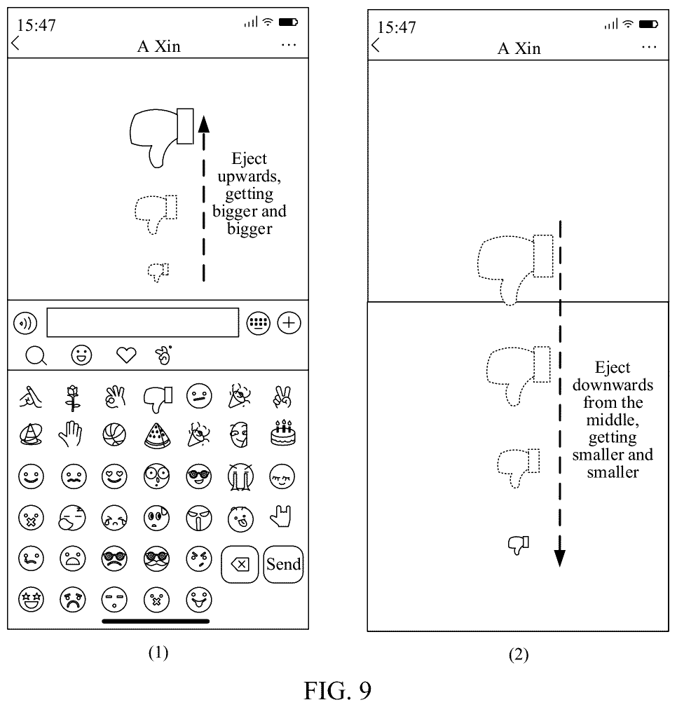

Referring to FIG. 9, FIG. 9 shows schematic diagrams showing ejection of a target emoticon element provided in an embodiment of this application. In part (1) of FIG. 9, in the process of the target emoticon element being ejected from the initial position to the upper edge of the session interface until leaving the session interface from the upper edge, the target emoticon element is controlled to become larger and larger. In part (2) of FIG. 9, in the process of the target emoticon element being ejected from the middle position of the session interface to the lower edge until leaving the session interface from the lower edge, the target emoticon element is controlled to become smaller and smaller. In this way, in the process of the target emoticon element being ejected, the size of the target emoticon element is changed, thereby further enriching emoticon display styles and enhancing the interactive interest.

In some embodiments, the terminal may further display an ejection animation of the target emoticon element being ejected in the session interface by: displaying a plurality of emoticon copies generated by the target emoticon element being ejected, and displaying a movement process of the plurality of emoticon copies in the session interface. In some embodiments, the terminal may further display the movement process of the plurality of emoticon copies by: displaying the movement process of the plurality of emoticon copies, and controlling the size of each of the emoticon copies to gradually change with the movement of the plurality of emoticon copies in the session interface; or, displaying a process of the plurality of emoticon copies moving sequentially along a target trajectory to form a target pattern in the session interface.

Here, in a practical application, in response to an ejection instruction for the target emoticon element, the terminal can control the generation of a plurality of emoticon copies of the target emoticon element (that is, a string of same emoticon elements), and display an ejection animation of the plurality of generated emoticon copies being ejected, where the emoticon copy is obtained by copying the target emoticon element, and the style of the emoticon copy is the same as that of the target emoticon element. In the process of ejecting the plurality of emoticon copies, the sizes of the plurality of emoticon copies may be controlled to change, and the plurality of emoticon copies may also be controlled to move sequentially along a target trajectory to form a target pattern, where the target trajectory or the target pattern may be set in advance or may be determined based on the session relationship between session objects (a sender and a receiver) in the session interface or the session date. If the session relationship between the session objects is a couple or the session date is Valentine's Day, the target pattern may be a “love” pattern.

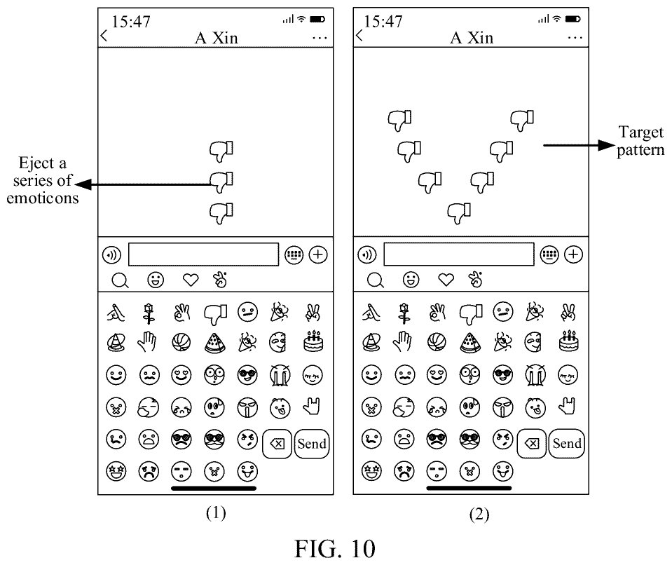

Referring to FIG. 10, FIG. 10 shows schematic diagrams showing ejection of a target emoticon element provided in an embodiment of this application. In response to an ejection instruction for the target emoticon element, the terminal generates a plurality of emoticon copies. Part (1) of FIG. 10 displays a process of the plurality of generated emoticon copies being ejected along the ejection direction instructed by the ejection instruction until leaving the session interface. In the ejection process, the size of each emoticon copy may be changed. Part (2) of FIG. 10 displays a process of the plurality of generated emoticon copies moving sequentially along a target trajectory corresponding to a target pattern. For example, in the movement process of the plurality of emoticon copies, the emoticon copies move sequentially along target trajectories corresponding to target patterns such as a “love” pattern and a V-shaped pattern to form corresponding target patterns. In this way, emoticon display styles are further enriched, the interactive interest is enhanced, and the visual perception of users is improved.

In some embodiments, when the target emoticon element is ejected to an end point, in the session interface, ejection information corresponding to the target emoticon element is displayed, where the ejection information includes at least one of the following information: an ejection height of the target emoticon element, and a special effect element corresponding to the ejection height.

The ejection height is associated with the accumulated force value before the ejection of the target emoticon element, where the larger the accumulated force value of the ejection, the higher the height at which the target emoticon element is ejected. Corresponding expression forms may be set for the special effect element corresponding to the ejection height according to the ejection height, where when the ejection height is higher, a “celebration” type special effect is presented, and when the ejection height is lower, a “cheer” type special effect is presented. Different expression forms may also be set for the special effect element according to the requirements of different holiday hotspots when the ejection operation is triggered. In a practical implementation, an ejection date corresponding to the ejection operation for the target emoticon element is determined; when the ejection date is a target date, the special effect element matched with the target date is obtained; and when the target emoticon element is ejected to an end point, ejection information corresponding to the emoticon element is displayed.

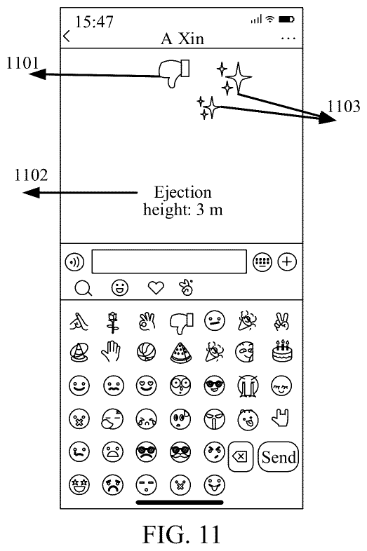

Referring to FIG. 11, FIG. 11 shows a schematic diagram showing display of ejection information provided in an embodiment of this application. A picture of a target emoticon element 1101 being ejected is displayed in the session interface, and when the target emoticon element 1101 is ejected to an end point, the ejection height (3 m) of the target emoticon element 1102 being ejected and a special effect element 1103 corresponding to the ejection height are displayed, where the special effect element 1103 may flicker in a target region of the session interface, or move from the top of the session interface to the bottom with the same or different movement trajectories and the same or different movement rates. For example, the special effect element may move from top to bottom in a free falling mode to achieve an animation special effect.

In some embodiments, after an ejection animation of the target emoticon element being ejected is displayed in the session interface, the target emoticon element is presented in the form of a session message in the session interface; or, text prompt information corresponding to the ejection animation and a playback entry corresponding to the ejection animation are presented in the form of a weak reminder session message. The text prompt information is used for prompting that an ejection operation is performed for the target emoticon element; and the playback entry is configured to redisplay an ejection animation of the target emoticon element being ejected when receiving a trigger operation for the playback entry, that is, the playback entry is triggered. Here, every time the user triggers the playback entry, the terminal replays the ejection animation of the target emoticon element being ejected. In some embodiments, the number of replays of the ejection animation may be set. When the number of replays of the ejection animation reaches the maximum limit, prompt information for prompting that the number of replays reaches the maximum limit is displayed. In this way, if the user still wants the terminal to display the ejection animation of the target emoticon element being ejected, the user can repeatedly trigger the ejection instruction for the target emoticon element to increase the number of human-computer interactions.

In a practical application, after the target emoticon element moves to the edge of the session interface and disappears (that is, after the ejection ends), whether to display the relevant information of the target emoticon element in the session interface may be determined according to needs. In some embodiments, the movement process of the target emoticon element being ejected in the session interface is completely synchronized between session objects (that is, a sender and a receiver). For example, when the sender ejects the target emoticon element, if the receiver is also in the session interface, the session interface on the receiver side synchronously displays the ejection animation of the target emoticon element being ejected; and if the receiver is not in the session interface, the session interface on the receiver side does not display the ejection animation, and after the ejection ends, the session interface does not display the target emoticon element in the form of a session message. In this way, the timeliness of the ejection display effect is ensured.

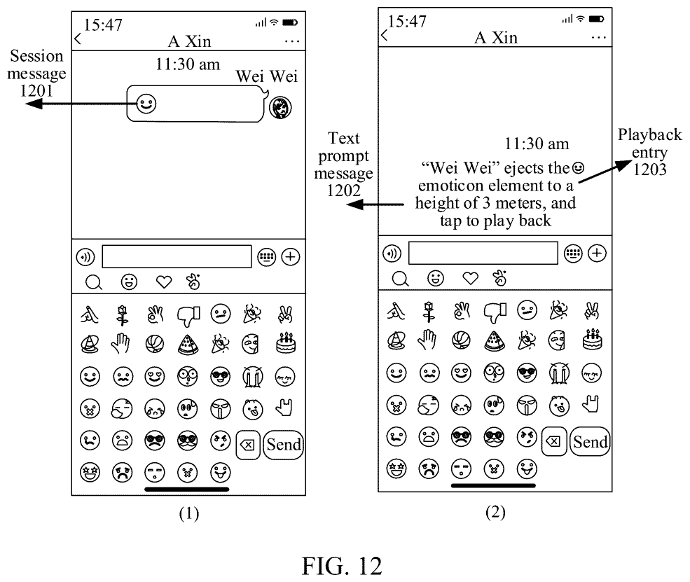

In some other embodiments, referring to FIG. 12, FIG. 12 shows schematic diagrams showing display of information provided in an embodiment of this application. After the ejection ends, part (1) of FIG. 12 displays a target emoticon element 1201 in the form of a session message in the session interface. In this way, after the display of the ejection animation ends, or even if the receiver is not in the session interface when the sender ejects the target emoticon element, the receiver may still see the target emoticon element sent by the sender in the subsequent session interface to avoid missing the session message. Part (2) of FIG. 12 presents text prompt information 1202 and a playback entry 1203 corresponding to the ejection animation in the form of a weak reminder session message. The user may understand that the sender performs the ejection operation for the target emoticon element through the text prompt information, and may redisplay the ejection animation of the target emoticon element being ejected in the session interface by tapping the playback entry, thereby achieving the playback of the ejection animation. In this way, even if the receiver is not in the session interface when the sender ejects the target emoticon element, the receiver may still review the ejection animation in the subsequent session interface to avoid missing the exciting picture, which is more conducive to the effective transmission of emotions between users.

In some embodiments, in the process of displaying an ejection animation of the target emoticon element being ejected, the terminal may also display an ejection animation of another emoticon element being ejected in the session interface. When the target emoticon element collides with another emoticon element, a collision special effect corresponding to the collision between the target emoticon element and another emoticon element is displayed.

Here, the another emoticon element may be an emoticon element ejected by any session object in the session interface, one or more (two or more) another emoticon elements may be provided, and ejection animations of the target emoticon element and another emoticon element being ejected may be displayed simultaneously in the session interface. When the target emoticon element collides with another emoticon element in the ejection process, a collision special effect corresponding to the collision between simulated physical entities may be displayed to enrich the display styles of emoticon elements and improve the interactive interest.

In some embodiments, the terminal may display a collision special effect corresponding to the collision between the target emoticon element and another emoticon element by: displaying a synthesized emoticon element synthesized by collision between the target emoticon element and the another emoticon element in a case that the target emoticon element and the another emoticon element are same emoticon elements, the synthesized emoticon element and the target emoticon element having a same style, and the synthesized emoticon element being larger than the target emoticon element; and displaying an animation in which the target emoticon element and the another emoticon element collide with each other and then are ejected in a case that the target emoticon element and the another emoticon element are different emoticon elements, or displaying a composite emoticon element combined by collision between the target emoticon element and the another emoticon element, where the target emoticon element and the another emoticon element are sub-emoticon elements of the composite emoticon element respectively.

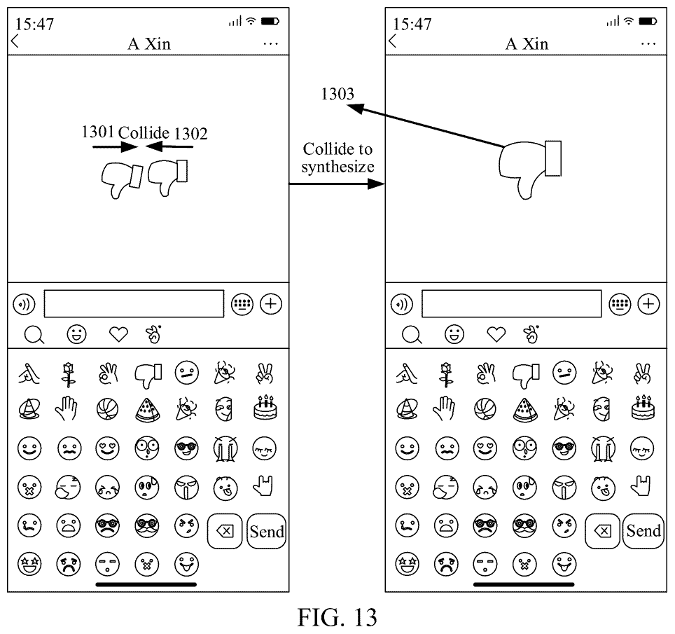

Referring to FIG. 13, FIG. 13 shows schematic diagrams showing collision between emoticon elements provided in an embodiment of this application. A target emoticon element 1301 and another emoticon element 1302 which are ejected are displayed in the session interface. The target emoticon element 1301 and the another emoticon element 1302 are same emoticon elements (with the same style and same size), which are both “dislike” style emoticon elements ( [symbol] ). As a result, a synthesized emoticon element 1303 synthesized by collision between the target emoticon element 1301 and the another emoticon element 1302 is still a “dislike” style emoticon element, but the synthesized emoticon element 1303 is larger than the target emoticon element 1301 and the another emoticon element 1302, that is, the synthesized “dislike” style emoticon element is larger than the single “dislike” style emoticon element before collision synthesis. The subsequent ejection trajectory of the finally synthesized emoticon element 1303 in the session interface is determined by the ejection speeds and ejection directions of the target emoticon element 1301 and the another emoticon element 1302 together before collision. In a practical application, the size of the synthesized emoticon element may also be related to the number of emoticon elements in collision. Usually, the larger the number of same emoticon elements in collision, the larger the synthesized emoticon element, that is, the synthesized emoticon element synthesized by collision of two same emoticon elements is smaller than the synthesized emoticon element synthesized by collision of three same emoticon elements.

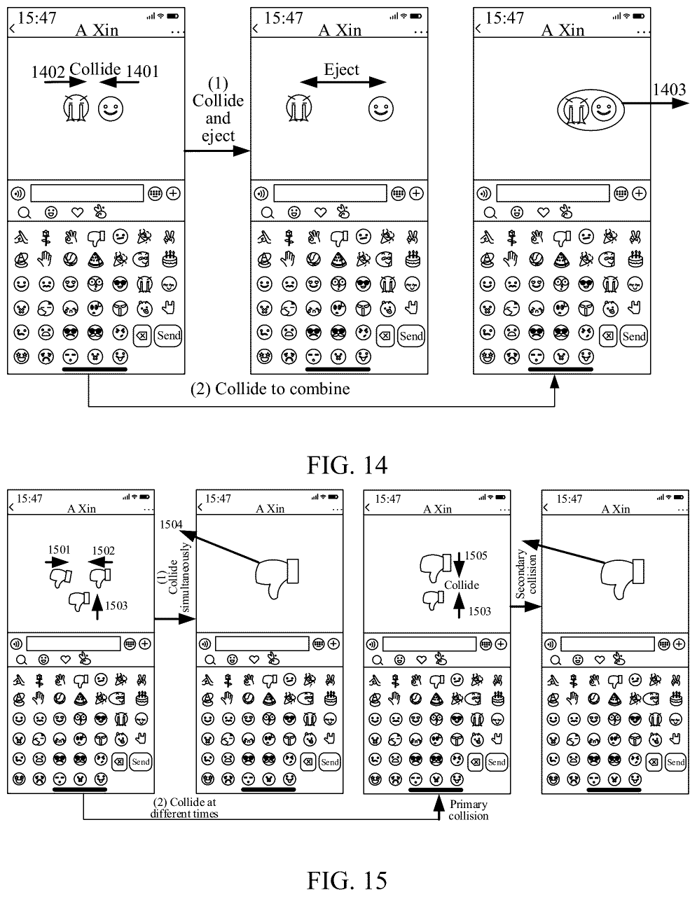

Referring to FIG. 14, FIG. 14 shows schematic diagrams showing collision between emoticon elements provided in an embodiment of this application. A target emoticon element 1401 (ejected “smile” emoticon) and another emoticon element 1402 (“cry” emoticon) are displayed in the session interface. The two emoticon elements are different emoticon elements. When the two emoticon elements collide, part (1) of FIG. 14 displays a picture in which the two emoticon elements collide with each other and then are ejected. In a practical application, the ejection amplitude of the two emoticon elements after collision is related to the ejection speeds and ejection directions of the two emoticon elements during collision, where the larger the ejection speeds of the two emoticon elements during collision between the two emoticon elements, the larger the corresponding ejection amplitude. Part (2) of FIG. 14 displays a composite emoticon element 1403 combined by collision between the two emoticon elements, where the target emoticon element 1401 and the another emoticon element 1402 in the composite emoticon element 1403 are independently displayed side by side.

In some embodiments, if two or more another emoticon elements are provided, three or more emoticon elements (including the target emoticon element) are displayed simultaneously in the session interface; if all another emoticon elements collide with the target emoticon element simultaneously, a collision special effect corresponding to the simultaneous collision is displayed; if all another emoticon elements do not collide with the target emoticon element simultaneously, a collision special effect corresponding to each collision is displayed; if all another emoticon elements include some emoticon elements which are the same as the target emoticon element and some emoticon elements which are different from the target emoticon element, when all emoticon elements collide simultaneously, a synthesized emoticon element synthesized by collision between the same emoticon elements may be displayed, and a picture of the different emoticon elements colliding and then being ejected may be displayed; and if all emoticon elements do not collide simultaneously, collision animations corresponding to the collision between some emoticon elements may be displayed successively.

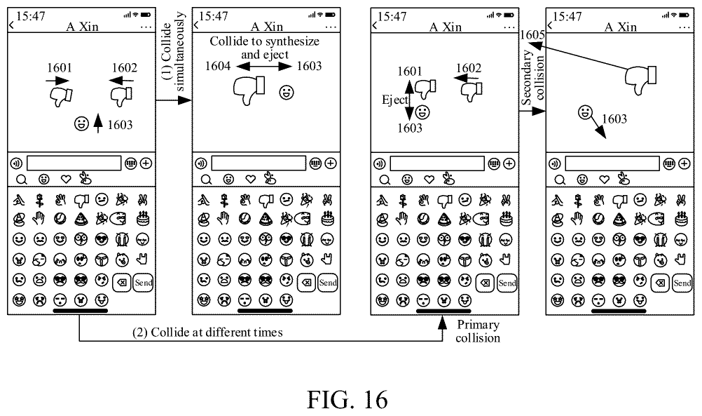

Referring to FIG. 15, FIG. 15 shows schematic diagrams showing collision between emoticon elements provided in an embodiment of this application. The session interface simultaneously displays three same ejected emoticon elements, such as a target emoticon element 1501, another emoticon element 1502 and another emoticon element 1503. In part (1) of FIG. 15, if the three same emoticon elements collide simultaneously, a synthesized emoticon element 1504 synthesized by simultaneous collision between the three emoticon elements is displayed. In part (2) of FIG. 15, if the target emoticon element 1501 collides with the another emoticon element 1502 first, a synthesized emoticon element 1505 synthesized by collision between the two emoticon elements is displayed; and then, if the another emoticon element 1503 collides with the synthesized emoticon element 1505, a synthesized emoticon element 1506 (larger than the synthesized element 1505) synthesized by collision between the another emoticon element 1503 and the synthesized emoticon element 1505 is displayed, and a process of the finally synthesized emoticon element 1506 moving in the session interface is displayed.

Referring to FIG. 16, FIG. 16 shows schematic diagrams showing collision between emoticon elements provided in an embodiment of this application. The session interface simultaneously displays three ejected emoticon elements, such as a target emoticon element 1601, another emoticon element 1602 and another emoticon element 1603, where the target emoticon element 1601 and the another emoticon element 1602 are same emoticon elements, and the another emoticon element 1603 is an emoticon element different from the target emoticon element 1601 and the another emoticon element 1602. In part (1) of FIG. 16, if the three emoticon elements collide simultaneously, a synthesized emoticon element 1604 synthesized by collision between the target emoticon element 1601 and the another emoticon element 1602 is displayed, and a picture in which the another emoticon element 1603 and the synthesized emoticon element 1604 collide with each other and then are ejected is displayed. In part (2) of FIG. 16, if the target emoticon element 1601 collides with the another emoticon element 1603 first, a picture in which the two emoticon elements collide with each other and then are ejected is displayed, and a movement process of each emoticon element after ejection is displayed; and if the another emoticon element 1603 collides with the another emoticon element 1602 subsequently, a synthesized emoticon element 1605 synthesized by collision between the another emoticon element 1603 and the another emoticon element 1602 is displayed, and a process of the finally synthesized emoticon element 1605 moving in the session interface is displayed.

Through the above mode, when a plurality of ejected emoticon elements are simultaneously displayed in the session interface, if the plurality of ejected emoticon elements collide, a corresponding collision special effect is displayed in combination with a physical phenomenon, thereby enriching the display styles of emoticon elements, improving the interactive interest, and increasing the utilization rate of hardware processing resources of terminals.

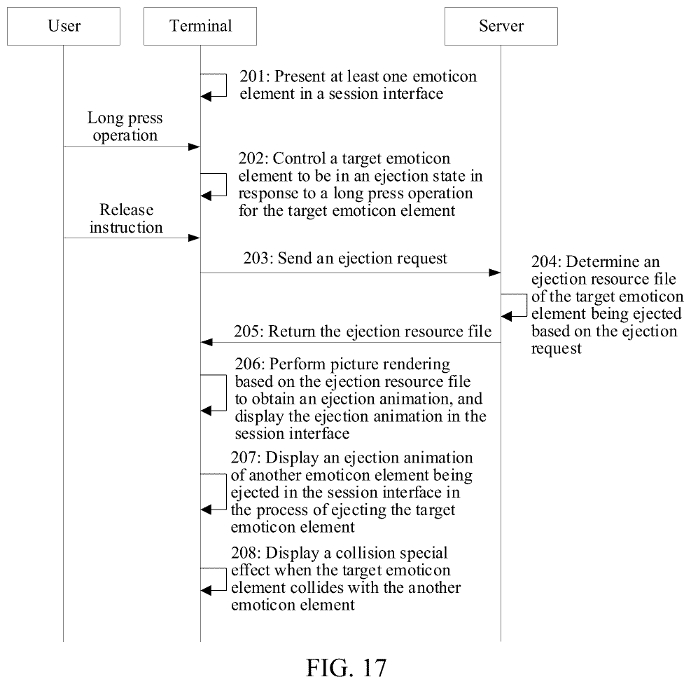

An exemplary application of an embodiment of this application in a practical application scene is described below. An information display method based on session provided in an embodiment of this application may be applied to an instant messaging application scene. A user may perform an ejection operation based on a plurality of selectable emoticon elements in an emoticon panel of a session interface. As shown in FIG. 17, when a user long presses a target emoticon element, a terminal controls the target emoticon element to be in an ejection state in response to the long press operation (that is, the foregoing ejection operation), and the user may adjust the ejection direction and distance by swiping with a finger. When the long press operation is released (loosened), the terminal receives an ejection instruction for the target emoticon element. In response to the ejection instruction, ejection processing is performed on the target emoticon element, and an ejection animation of the target emoticon element being ejected is displayed in a session interface, so that a session object in the session interface may view the process of the target emoticon element being ejected, such as an ejection trajectory of the target emoticon element being ejected. After the ejected target emoticon element is ejected to an end point (that is, ejected out of the session interface), the display of the ejection animation in the session interface ends.

In a practical application, after the ejection ends, whether to display the relevant information of the target emoticon element in the session interface may be determined according to needs. In some embodiments, the movement process of the target emoticon element being ejected in the session interface is completely synchronized between session objects (that is, a sender and a receiver). For example, when the sender ejects the target emoticon element, if the receiver is also in the session interface, the session interface on the receiver side synchronously displays the ejection animation of the target emoticon element being ejected; and if the receiver is not in the session interface, the session interface on the receiver side does not display the ejection animation, and after the ejection ends, the session interface does not display the target emoticon element in the form of a session message. In this way, the timeliness of the ejection display effect is ensured. In some other embodiments, after the ejection ends, the target emoticon element may be presented in the form of a session message in the session interface, or the text prompt information and the playback entry corresponding to the ejection animation may be presented in the form of a weak reminder session message. The user may understand that the sender performs the ejection operation for the target emoticon element through the text prompt information, and may redisplay the ejection animation of the target emoticon element being ejected in the session interface by tapping the playback entry, thereby achieving the playback of the ejection animation. In this way, even if the receiver is not in the session interface when the sender ejects the target emoticon element, the receiver may still review the ejection animation in the subsequent session interface to avoid missing the exciting picture, which is more conducive to the effective transmission of emotions between users.

In addition, when there are a plurality of ejected emoticon elements in the session interface, if the plurality of ejected emoticon elements collide, the terminal will display a collision special effect simulating physical collision in the session interface. For example, when a plurality of emoticon elements in collision are same emoticon elements, a synthesized emoticon element synthesized by collision between the plurality of same emoticon elements is displayed. The synthesized emoticon element and each emoticon element before collision have the same style, but the size of the synthesized emoticon element is larger than the size of each emoticon element before collision. As shown in FIG. 13, two same “dislike” emoticon elements collide to synthesize a big “dislike” emoticon element. When a plurality of emoticon elements in collision are different emoticon elements, a picture in which a plurality of different emoticon elements collide with each other and then are ejected is displayed. As shown in FIG. 14, different “smile” emoticon element and “cry” emoticon element collide with each other and then are reflected. In this way, the richness of information display is greatly improved, and the interactive interest is enhanced, thereby being conducive to promoting the interactive enthusiasm based on emoticon elements to improve the user viscosity and retention rate.

The technical implementation of the foregoing ejection effect is described below. Referring to FIG. 17, FIG. 17 shows a schematic flowchart of an information display method based on session provided in an embodiment of this application. The method includes:

Step 201: Present, by a terminal, at least one emoticon element in a session interface.

Here, when a user engages in a session through a client on the terminal, the emoticon element may be edited through an emoticon entry. For example, the terminal presents a plurality of emoticon elements on an emoticon panel in response to a tap operation for the emoticon entry, so that the user can select any one of the emoticon elements for ejection.

Step 202: Control a target emoticon element to be in an ejection state in response to a long press operation for the target emoticon element.

In a practical application, designers can design trigger logics (such as ejection logics and collision logics) of each emoticon element to obtain an ejection logic file, and send the ejection logic file to the terminal through a backend server corresponding to the client. When the user triggers the ejection logics for the target emoticon element, the terminal controls the target emoticon element to be in an ejection state based on the ejection logic file, and presents ejection indication information for the target emoticon element, where the ejection indication information is used for indicating an ejection direction or an ejection distance. As shown by the arrow in FIG. 6, the direction of the arrow indicates the ejection direction, and the length of the arrow indicates the ejection distance. The user can adjust the ejection direction and the ejection distance by swiping or rotating the target emoticon element.

Step 203: Send, by the terminal, an ejection request for the target emoticon element to a server in response to a release instruction for the long press operation.

The ejection request carries an emoticon identifier of the target emoticon element and a session identifier, and is used for requesting an ejection resource file corresponding to an ejection animation to be displayed when the target emoticon element is ejected.

Step 204: Determine, by the server, the ejection resource file of the target emoticon element being ejected based on the ejection request.

In a practical application, designers can carry out template design for the ejection animation effect of each emoticon element being ejected in the emoticon panel and the animation effect after collision between a plurality of emoticon elements to obtain an ejection resource file, and store the ejection resource file in the backend server of the client; and when the server receives the ejection request for the target emoticon element sent by the terminal, the corresponding ejection resource file is obtained based on the emoticon identifier.

Step 205: Return, by the server, the determined ejection resource file to a terminal of a session object.

Here, the server determines each session object in the session interface based on the session identifier, and synchronously sends the ejection resource file to the terminal of each session object, such as causing the terminals of a sender and a receiver by creating threads to perform rendering synchronously.

Step 206: Perform, by the terminal, picture rendering based on the ejection resource file to obtain an ejection animation, and display the ejection animation in the session interface.

Here, the terminal performs picture rendering according to a template in the ejection resource file based on the ejection direction and ejection distance corresponding to the long press operation to obtain an ejection animation of the target emoticon element being ejected, and displays the ejection animation obtained by rendering.

Step 207: Display, by the terminal, an ejection animation of another emoticon element being ejected in the session interface in the process of ejecting the target emoticon element.

Step 208: Display a collision special effect when the target emoticon element collides with the another emoticon element.

Here, when the target emoticon element collides with the another emoticon element, the terminal performs picture rendering according to a collision template in the ejection resource file to obtain a corresponding collision animation or collision special effect, and displays the collision animation or collision special effect obtained by rendering.

Through the above mode, when a session is conducted based on an emoticon element, an ejection animation of the emoticon element being ejected is displayed in the session interface through the ejection of the emoticon element; and when a plurality of ejected emoticon elements are displayed in the session interface and the plurality of emoticon elements collide, a corresponding collision special effect is displayed. Compared with the mode of presenting a session message containing an emoticon element only by sending the emoticon element, the richness of information display is greatly improved, the interactive interest is enhanced, and the increasingly diversified display needs of user information interaction are met.

The following continues to describe an exemplary structure of an information display apparatus 555 based on session provided in an embodiment of this application implemented as a software module. In some embodiments, the software module stored in the information display apparatus 555 based on session of the memory 550 in FIG. 2 may include: a first presentation module 5551, configured to present at least one emoticon element in a session interface, the session interface being configured to implement a session with at least one session object; a second presentation module 5552, configured to present ejection guidance information corresponding to the target emoticon element in response to an ejection operation for a target emoticon element in the at least one emoticon element; and an ejection display module 5553, configured to display an ejection animation of the target emoticon element being ejected in response to an ejection instruction triggered based on the ejection guidance information.

In some embodiments, before the operation of presenting ejection guidance information corresponding to the target emoticon element, the apparatus further includes: an operation receiving module, configured to receive a trigger operation for the target emoticon element in the at least one emoticon element, and determine the trigger operation as the ejection operation in a case that the trigger operation meets at least one of the following conditions: a trigger duration reaches a target duration, a trigger displacement reaches a target displacement, and a trigger trajectory is a target trajectory; or, receive an operation combination for the target emoticon element in the at least one emoticon element, the operation combination including at least two continuous operations, and determine the operation combination as the ejection operation in a case that the operation combination is consistent with a target operation combination.

In some embodiments, before the operation of presenting ejection guidance information corresponding to the target emoticon element, the operation receiving module is further configured to present a transmitting mode selection interface for selecting a transmitting mode of the target emoticon element in response to a trigger operation for the target emoticon element in the at least one emoticon element, where the transmitting mode selection interface at least includes an ejection mode option; and determine the selection operation as the ejection operation in response to a selection operation for the ejection mode option.

In some embodiments, after the operation of presenting ejection guidance information corresponding to the target emoticon element, the apparatus further includes: an instruction receiving module, configured to display a process of dragging the target emoticon element in response to a drag operation for the target emoticon element triggered based on the ejection guidance information; and receive the ejection instruction in response to a release instruction for the drag operation.

In some embodiments, before the operation of receiving the ejection instruction, the apparatus further includes: a direction adjusting module, configured to adjust an ejection direction of the target emoticon element in response to a rotation operation for the target emoticon element; and the instruction receiving module is further configured to receive an ejection instruction for instructing ejection in the adjusted ejection direction.

In some embodiments, the ejection display module is further configured to display a process of the target emoticon element being ejected and then moving to an edge of the session interface and disappearing in the session interface; and the apparatus further includes: a third presentation module, configured to present the target emoticon element in the form of a session message in the session interface.

In some embodiments, the ejection display module is further configured to display a process of the target emoticon element being ejected and moving along the ejection direction instructed by the ejection instruction in the session interface; and control the size of the target emoticon element to gradually change with the movement of the target emoticon element.

In some embodiments, the ejection display module is further configured to display a plurality of emoticon copies generated by the target emoticon element being ejected, and display a movement process of the plurality of emoticon copies in the session interface.

In some embodiments, the ejection display module is further configured to display a movement process of the plurality of emoticon copies, and control the size of each of the emoticon copies to gradually change with the movement of the plurality of emoticon copies in the session interface; or, display a process of the plurality of emoticon copies moving sequentially along a target trajectory to form a target pattern in the session interface.

In some embodiments, the apparatus further includes: a fourth presentation module, configured to display ejection information corresponding to the target emoticon element in the session interface in a case that the target emoticon element is ejected to an end point, where the ejection information includes at least one of the following information: an ejection height of the target emoticon element, and a special effect element corresponding to the ejection height.

In some embodiments, after the operation of displaying an ejection animation of the target emoticon element being ejected in the session interface, the apparatus further includes: a fifth presentation module, configured to present text prompt information corresponding to the ejection animation and a playback entry corresponding to the ejection animation in the form of a weak reminder session message, where the text prompt information is used for prompting that an ejection operation is performed for the target emoticon element; and the playback entry is configured to redisplay an ejection animation of the target emoticon element being ejected when receiving a trigger operation for the playback entry.

In some embodiments, the apparatus further includes: a collision display module, configured to display an ejection animation of another emoticon element being ejected in the session interface in the process of displaying an ejection animation of the target emoticon element being ejected; and display a collision special effect corresponding to the collision between the target emoticon element and the another emoticon element in a case that the target emoticon element collides with the another emoticon element.

In some embodiments, the collision display module is further configured to display a synthesized emoticon element synthesized by collision between the target emoticon element and the another emoticon element in a case that the target emoticon element and the another emoticon element are same emoticon elements, the synthesized emoticon element and the target emoticon element having a same style, and the synthesized emoticon element being larger than the target emoticon element; and display an animation in which the target emoticon element and the another emoticon element collide with each other and then are ejected in a case that the target emoticon element and the another emoticon element are different emoticon elements, or display a composite emoticon element combined by collision between the target emoticon element and the another emoticon element, where the target emoticon element and the another emoticon element are sub-emoticon elements of the composite emoticon element respectively.

In some embodiments, after the operation of presenting ejection guidance information corresponding to the target emoticon element, the instruction receiving module is further configured to present a first ejection auxiliary tool of the ejection prop in a case that the presentation form of the ejection guidance information is an ejection prop carrying the target emoticon element; display a process of dragging the ejection prop and a process of dragging the ejection prop to deform the first ejection auxiliary tool in response to a drag operation for the ejection prop; and receive the ejection instruction in a case that the drag operation is released during the dragging process. The ejection display module is further configured to display an animation of the target emoticon element being ejected under the action of the elastic force generated by the first ejection auxiliary tool restoring to an original shape in the session interface.

In some embodiments, the apparatus further includes: a style adjusting module, configured to adjust the display style of the first ejection auxiliary tool with the change of the position of the ejection prop in the process of dragging the ejection prop, so as to enable the display style of the first ejection auxiliary tool to correspond to the position of the ejection prop.

In some embodiments, after the operation of presenting ejection guidance information corresponding to the target emoticon element, the instruction receiving module is further configured to present a second ejection auxiliary tool connected to the ejection prop in response to a trigger operation for the ejection prop in a case that the presentation form of the ejection guidance information is an ejection prop carrying the target emoticon element; display a movement process of the second ejection auxiliary tool and display a process of stretching deformation of a connecting member between the second ejection auxiliary tool and the ejection prop with the movement of the second ejection auxiliary tool in response to a drag operation for the second ejection auxiliary tool; and receive the ejection instruction in response to a release instruction for the drag operation. The ejection display module is further configured to display an ejection animation of the target emoticon element being ejected under the action of the elastic force generated by stretching deformation of the connecting member in the session interface.

An embodiment of this application provides a computer program product or a computer program, the computer program product or the computer program includes a computer instruction, and the computer instruction is stored in a computer-readable storage medium. A processor of a computer device reads the computer instruction from the computer-readable storage medium, and the processor executes the computer instruction, so that the computer device performs the foregoing information display method based on session in the embodiment of this application.

An embodiment of this application provides a computer-readable storage medium storing an executable instruction. When the executable instruction is executed by a processor, the processor will perform the information display method based on session provided in the embodiment of this application, such as the method shown in FIG. 3.

In some embodiments, the computer-readable storage medium may be a ferroelectric random access memory (FRAM), a read only memory (ROM), a programmable read only memory (PROM), an erasable programmable read only memory (EPROM), a static random access memory (SRAM), an electrically erasable programmable read-only memory (EEPROM), a flash memory, a magnetic surface memory, an optical disk, a compact disc-read only memory (CD-ROM), or the like; or may be various devices including one of or any combination of the foregoing memories.

In some embodiments, the executable instruction may be written in the form of programs, software, software modules, scripts or codes in any form of programming languages (including compiled or interpreted languages, or declarative or procedural languages), and may be deployed in any form, including being deployed as a stand-alone program, a module, a component, a sub-routine or another unit suitable for use in a computing environment.

As an example, the executable instruction may, but not necessarily, correspond to a file in a file system, and may be stored in a part of the file for saving other programs or data, for example, stored in one or more scripts in a hyper text markup language (HTML) document, stored in a single file dedicated to the program in question, or stored in multiple collaborative files (such as files for storing one or more modules, sub-programs, or codes).

As an example, the executable instruction may be deployed to be executed on a computing device, or executed on multiple computing devices at the same location, or executed on multiple computing devices which are distributed in multiple locations and interconnected through a communication network.

The foregoing descriptions are merely embodiments of this application and are not intended to limit the protection scope of this application. Any modification, equivalent replacement, or improvement made within the spirit and scope of this application shall fall within the protection scope of this application.

What is claimed is:

1. An information display method based on session, performed by an electronic device, comprising:
presenting at least one emoticon element in a session interface, the session interface being configured to implement a session with at least one session object;
in response to an ejection operation for a target emoticon element in the at least one emoticon element, presenting ejection guidance information corresponding to the target emoticon element; and
displaying an ejection animation of the target emoticon element being ejected in response to an ejection instruction triggered based on the ejection guidance information.

2. The method according to claim 1, further comprising:
receiving a trigger operation for the target emoticon element, and determining the trigger operation as the ejection operation in response to the trigger operation meeting at least one of following conditions: a trigger duration reaches a target duration, a trigger displacement reaches a target displacement, and a trigger trajectory is a target trajectory; or
receiving an operation combination including at least two continuous operations for the target emoticon element, and determining the operation combination as the ejection operation in response to the operation combination being consistent with a target operation combination.

3. The method according to claim 1, further comprising:
in response to a trigger operation for the target emoticon element, presenting mode options for selecting a transmitting mode of the target emoticon element; and
in response to a selection operation for an ejection mode option, determining the selection operation as the ejection operation.

4. The method according to claim 1, further comprising:
displaying a process of dragging the target emoticon element in response to a drag operation for the target emoticon element triggered based on the ejection guidance information; and
receiving the ejection instruction in response to a release instruction for the drag operation in a process of performing the drag operation.

5. The method according to claim 4, further comprising:
adjusting an ejection direction of the target emoticon element to obtain an adjusted ejection direction in response to a rotation operation for the target emoticon element;
wherein receiving the ejection instruction includes:
receiving an ejection instruction for instructing ejection in the adjusted ejection direction.

6. The method according to claim 1, wherein displaying the ejection animation of the target emoticon element being ejected includes:
displaying, in the session interface, a process of the target emoticon element being ejected and then moving to an edge of the session interface and disappearing.

7. The method according to claim 1, wherein displaying the ejection animation of the target emoticon element being ejected includes:
displaying a process of the target emoticon element being ejected and moving along an ejection direction indicated by the ejection instruction; and
controlling a size of the target emoticon element to gradually change with movement of the target emoticon element.

8. The method according to claim 1, wherein displaying the ejection animation of the target emoticon element being ejected includes:
displaying a plurality of emoticon copies generated in response to the target emoticon element being ejected, and displaying a movement process of the plurality of emoticon copies.

9. The method according to claim 8, wherein displaying the movement process of the plurality of emoticon copies includes:
displaying movement of the plurality of emoticon copies, and controlling a size of each of the emoticon copies to gradually change with the movement of the plurality of emoticon copies; or
displaying a process of the plurality of emoticon copies moving sequentially along a target trajectory to form a target pattern.

10. The method according to claim 1, further comprising:
displaying ejection information corresponding to the target emoticon element in the session interface in response to the target emoticon element being ejected to an end point;
wherein the ejection information includes at least one of following information: an ejection height of the target emoticon element, and a special effect element corresponding to the ejection height.

11. The method according to claim 1, further comprising:
presenting the target emoticon element in a form of a session message in the session interface; or
presenting, in a form of a weak reminder session message, text prompt information corresponding to the ejection animation and a playback entry corresponding to the ejection animation, wherein:
the text prompt information is used for prompting that the ejection operation is performed for the target emoticon element; and
the playback entry is configured to, when triggered, redisplay the ejection animation of the target emoticon element being ejected.

12. The method according to claim 1, further comprising:
displaying an ejection animation of another emoticon element being ejected in a process of displaying the ejection animation; and
displaying a collision special effect corresponding to a collision between the target emoticon element and the another emoticon element in response to the target emoticon element colliding with the another emoticon element.

13. The method according to claim 12, wherein displaying the collision special effect includes:
in response to the target emoticon element and the another emoticon element being same emoticon elements, displaying a synthesized emoticon element, the synthesized emoticon element and the target emoticon element having a same style, and the synthesized emoticon element being larger than the target emoticon element; and
in response to the target emoticon element and the another emoticon element being different emoticon elements:
displaying an animation in which the target emoticon element and the another emoticon element collide with each other and then are ejected, or
displaying a composite emoticon element combined by collision between the target emoticon element and the another emoticon element, the target emoticon element and the another emoticon element being sub-emoticon elements of the composite emoticon element.

14. The method according to claim 1,
wherein a presentation form of the ejection guidance information is an ejection prop carrying the target emoticon element;
the method further comprising:
presenting an ejection auxiliary tool of the ejection prop;
in response to a drag operation for the ejection prop, displaying a process of dragging the ejection prop and deformation of the ejection auxiliary tool; and
receiving the ejection instruction in response to the drag operation is released during the process of dragging the ejection prop;
wherein displaying the ejection animation of the target emoticon element being ejected includes:
displaying an animation of the target emoticon element being ejected under an action of an elastic force generated by the ejection auxiliary tool restoring to an original shape.

15. The method according to claim 14, further comprising:
adjusting a display style of the ejection auxiliary tool with a change of a position of the ejection prop in the process of dragging the ejection prop, so as to enable the display style of the ejection auxiliary tool to correspond to the position of the ejection prop.

16. The method according to claim 1,
wherein a presentation form of the ejection guidance information is an ejection prop carrying the target emoticon element;
the method further comprising:
presenting an ejection auxiliary tool connected to the ejection prop in response to a trigger operation for the ejection prop;
in response to a drag operation for the ejection auxiliary tool, displaying a movement process of the ejection auxiliary tool and displaying a process of stretching deformation of a connecting member between the ejection auxiliary tool and the ejection prop with movement of the ejection auxiliary tool; and
receiving the ejection instruction in response to the drag operation is released during a process of dragging the ejection auxiliary tool;
wherein displaying the ejection animation of the target emoticon element being ejected includes:
displaying an ejection animation of the target emoticon element being ejected under an action of an elastic force generated by stretching deformation of the connecting member.

17. An electronic device comprising:
one or more memories storing one or more executable instructions; and
one or more processors configured to execute the one or more executable instructions to:
present at least one emoticon element in a session interface, the session interface being configured to implement a session with at least one session object;
in response to an ejection operation for a target emoticon element in the at least one emoticon element, present ejection guidance information corresponding to the target emoticon element; and
display an ejection animation of the target emoticon element being ejected in response to an ejection instruction triggered based on the ejection guidance information.

18. The electronic device according to claim 17, wherein the one or more processors are further configured to execute the one or more executable instructions to:
receive a trigger operation for the target emoticon element, and determine the trigger operation as the ejection operation in response to the trigger operation meeting at least one of following conditions: a trigger duration reaches a target duration, a trigger displacement reaches a target displacement, and a trigger trajectory is a target trajectory; or
receive an operation combination including at least two continuous operations for the target emoticon element, and determine the operation combination as the ejection operation in response to the operation combination being consistent with a target operation combination.

19. The electronic device according to claim 17, wherein the one or more processors are further configured to execute the one or more executable instructions to:
in response to a trigger operation for the target emoticon element, present mode options for selecting a transmitting mode of the target emoticon element; and
in response to a selection operation for an ejection mode option, determine the selection operation as the ejection operation.

20. A computer-readable storage medium storing one or more executable instructions that, when executed by one or more processors, cause the one or more processors to:
present at least one emoticon element in a session interface, the session interface being configured to implement a session with at least one session object;
in response to an ejection operation for a target emoticon element in the at least one emoticon element, present ejection guidance information corresponding to the target emoticon element; and
display an ejection animation of the target emoticon element being ejected in response to an ejection instruction triggered based on the ejection guidance information.
